(19) United States
(12) Patent Application Publication
(10) Pub. No.: US 2010/0165243 A1
(43) Pub. Date: Jul. 1, 2010

(54) PRISM SHEET, BACK LIGHT UNIT AND LIQUID CRYSTAL DISPLAY DEVICE HAVING THE SAME

(76) Inventors: Hyeok-Joon Yoon, Gyeongangbuk-Do (KR); Ju Ilun Min, Gyeongangnam-Do (KR); Sung-Hun Kim, Gyeongangbuk-Do (KR)

Correspondence Address: BIRCH STEWART KOLASCH & BIRCH, PO BOX 747, FALLS CHURCH, VA, 22040-0747, US

(21) Appl. No.: 12/642,289

(22) Filed: Dec. 18, 2009

(30) Foreign Application Priority Data
Dec. 31, 2008 (KR) 10-2008-0138696

(51) Int. Cl. G02F 1/1335; F21V 11/00; F21V 7/04

(52) U.S. Cl. 349/62; 362/351; 362/606

(57) ABSTRACT

A prism sheet prevents the occurrence of a moiré pattern and a wet-out phenomenon by increasing irregularity of prisms formed thereon, by configuring the prisms adjacent to each other to have different heights, and by differently forming widths of triangular sectional surfaces of one prism according to positions. As the height difference of the prisms adjacent to each other is set as 1.2-1.5 μm, a pressure applied to the prism sheet is distributed to the prisms. This may prevent deformation of the prisms.

This application claims the benefit of Korean Patent Application No. 10-2008-0138696, filed on Dec. 31, 2008, which is hereby incorporated by reference as if fully set forth herein.

### BACKGROUND OF THE INVENTION

1. Field of the Invention

The present invention relates to a prism sheet, and particularly, to a prism sheet capable of preventing a moiré pattern by irregularly forming prisms, and capable of preventing deformation of the prisms due to a pressure by uniformly distributing the pressure to the prisms, a backlight unit, and a liquid crystal display (LCD) device having the same.

2. Background of the Invention

Recently, various portable electric devices, such as mobile phones, personal digital assistant (PDA), and note book computers have been developed, because of their small size, light weight, and power-efficient operations. Accordingly, flat panel display devices, such as liquid crystal displays (LCDs), plasma display panels (PDPs), field emission displays (FEDs), and vacuum fluorescent displays (VFDs), have been developed. Of these flat panel display devices, the LCDs are currently massively produced because of their simple driving scheme and superior image quality.

The LCD device is a transmissive type display device, and displays a desired image on a screen by controlling an amount of light passing through a liquid crystal layer by a refraction anisotropy of a liquid crystal molecule. Accordingly, the LCD device is provided with a backlight, an optical source passing through a liquid crystal layer for an image display. The backlight is generally divided into an edge type backlight that a lamp is installed on a side surface of a liquid crystal panel thus to provide light to a liquid crystal layer, and a direct type backlight that a lamp is installed below a liquid crystal panel thus to directly provide light to a liquid crystal layer.

According to the edge type backlight, a lamp is installed on a side surface of a liquid crystal panel thus to provide light to a liquid crystal layer through a reflector and a light guide panel. Accordingly, the edge type backlight has a thin thickness thereby to be mainly applied to a notebook, etc.

According to the direct type backlight, light emitted from a lamp is directly supplied to a liquid crystal layer. Accordingly, the direct type backlight can be applied to a liquid crystal panel of a large area, and a high brightness can be implemented. Therefore, the direct type backlight is mainly used to fabricate a liquid crystal panel for an LCD TV.

FIG. 1 is a view showing a structure of an LCD device having an edge type backlight in accordance with the conventional art.

As shown in FIG. 1, the LCD device 1 comprises an LC panel 3, and a backlight 10 installed on a rear surface of the LC panel 3 and providing light to the LC panel 3. The LC panel 3 for implementing a substantial image includes a transparent first substrate 3a such as glass, a second substrate 3b, and an LC layer (not shown) formed therebetween. Although not shown, the first substrate 3a is a thin film transistor (TFT) substrate where a driving device such as a TFT and a pixel electrode are formed, and the second substrate 3b is a color filter substrate where a color filter layer is formed. A driving circuit unit 5 is provided on a side surface of the first substrate 3a, and applies a signal to the TFT and the pixel electrode formed at the first substrate 3a, respectively.

The backlight 10 includes a plurality of lamps 11 for substantially emitting light, a light guide panel 13 for guiding light emitted from the lamps 11 to the LC panel 3, a reflector 17 for reflecting light emitted from the lamps 11 thereby enhancing optical efficiency, and an optical sheet composed of a diffusion sheet 15 and a prism sheet 20 disposed above the light guide panel 13.

Light emitted from the lamps 11 installed on both side surfaces of the light guide panel 13 of the backlight 10 is made to be incident on the light guide panel 13 through side surfaces of the light guide panel 13. Then, the incident light is supplied to the LC panel 3 through an upper surface of the light guide panel 13. Next, the supplied light has enhanced optical efficiency by the optical sheet, and then is made to be incident onto the LC panel 3.

Light emitted from the light guide panel 13 is made to be incident onto the diffusion sheet 20 15 and the prism sheet 20. Then, the incident light is diffused by the diffusion sheet, and a progress direction of the incident light is changed to a front side by the prism sheet 20 thus to be outputted.

The prism sheet 20 is provided above the diffusion sheet 15, and is fabricated by forming a regular prism formed of acryl resin on a base film formed of polyester (PET). The prism sheet 20 is shown in FIG. 2.

As shown in FIG. 2, the prism sheet 20 is composed of a plurality of sheets, and concentrates light diffused by the diffusion sheet 15. On a first prism sheet 20a and a second prism sheet 20b, a plurality of prisms 22a and 22b having triangle shaped cross sections are formed, respectively. The first prisms 22a and the second prisms 22b are formed to be extending from one side surface to another side surface of the first prism sheet 20a and the second prism sheet 20b, respectively. That is, as the prisms having triangle shaped cross sections are formed from one side to another side, mountains and valley portions are extending from one side to another side of the first prism sheet 20a and the second prism sheet 20b, respectively. Here, the first prisms 22a on the first prism sheet 20a, and the second prisms 22b on the second prism sheet 20b are extending to be perpendicular to each other, thereby concentrating light in horizontal and vertical directions.

However, the conventional prism sheet having a plurality of prism sheets may have the following problems.

When humidity is introduced into the LCD device, the surfaces of the first prisms 22a on the first prism sheet 20a are wet by the humidity. Due to the humidity on the surfaces of the first prisms 22a, the first prisms 22a come in contact with the second prism sheet 20b disposed thereabove. This is called as a ‘wet-out’ phenomenon. Due to the wet-out phenomenon, the first prism sheet 22a and the second prism sheet 22b cling to each other by the humidity. This may cause inferiority of the LCD device.

### SUMMARY OF THE INVENTION

Therefore, an object of the present invention is to provide a prism sheet capable of preventing inferiority of prisms due to a pressure, by uniformly distributing an applied pressure to the prisms formed on the prism sheet.

Another object of the present invention is to provide a backlight unit having the prism sheet, and a liquid crystal display (LCD) device having the same.

To achieve these and other advantages and in accordance with the purpose of the present invention, as embodied and broadly described herein, there is provided a prism sheet, comprising: a base film; and a plurality of prisms formed on the base film, the prism being extended from one side to another side of the base film and having triangle shaped cross section, wherein the prisms adjacent to each other have different heights, and a height difference between the adjacent prisms is approximately 1.2-1.5 μm.

The prisms adjacent to each other may have heights of 27 μm and 25.5-25.8 μm, and bottom widths of the triangle shaped cross sections of one prism may be different according to positions.

To achieve these and other advantages and in accordance with the purpose of the present invention, as embodied and broadly described herein, there is also provided a backlight unit, comprising: at least one lamp for emitting light; a light guide panel for guiding the light emitted from the lamp; at least one diffusion sheet above the light guide panel to diffuse the light incident from the light guide panel; a first prism sheet having a plurality of prisms formed thereon to concentrate the incident light, the prisms having triangle shaped cross section and height differences between the adjacent prisms is approximately 1.2-1.5 μm; and a second prism sheet above the first prism sheet, the second prism having a plurality of prisms of triangle shaped cross section.

The present invention may have the following advantages.

The prisms on the prism sheet may be formed to have different heights from each other, and the height difference therebetween may be in a range of 1.2-1.5 μm. This may prevent the occurrence of a moiré pattern, and prevent deformation of the prisms due to a pressure.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a structure of a liquid crystal display (LCD) device in accordance with the conventional art;

FIG. 2 is a view showing a prism sheet of the LCD device in accordance with the conventional art;

FIG. 3 is a disassembled perspective view showing a structure of an LCD device according to the present invention;

FIG. 4 is a view showing a structure of an LC panel of the LCD device according to the present invention;

FIG. 5 is a view showing a structure of a first prism sheet of the LCD device according to the present invention;

FIG. 6 is a partially enlarged sectional view of the first prism sheet of the LCD device according to the present invention; and

FIG. 7 is a view showing a state when a pressure is applied to a prism sheet of the LCD device according to the present invention.

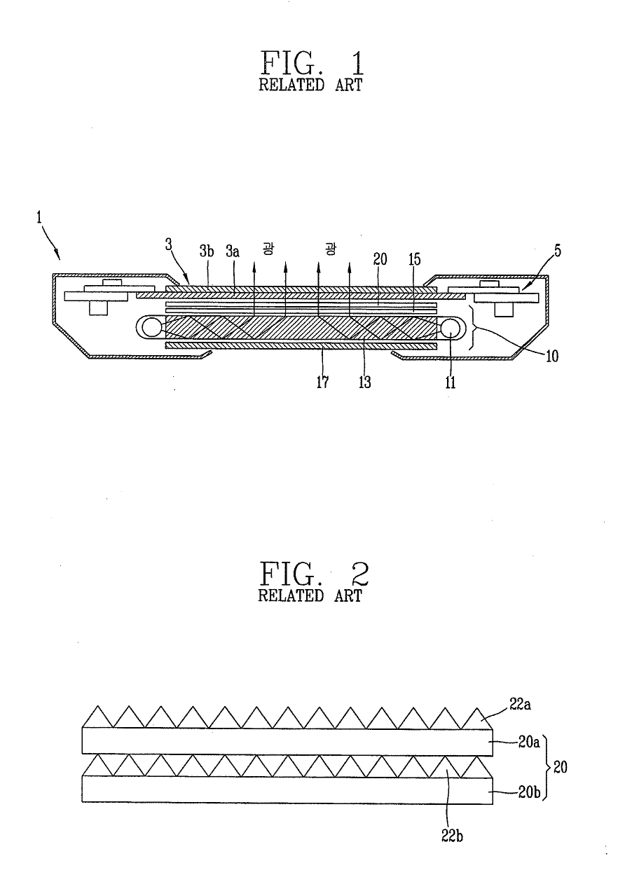

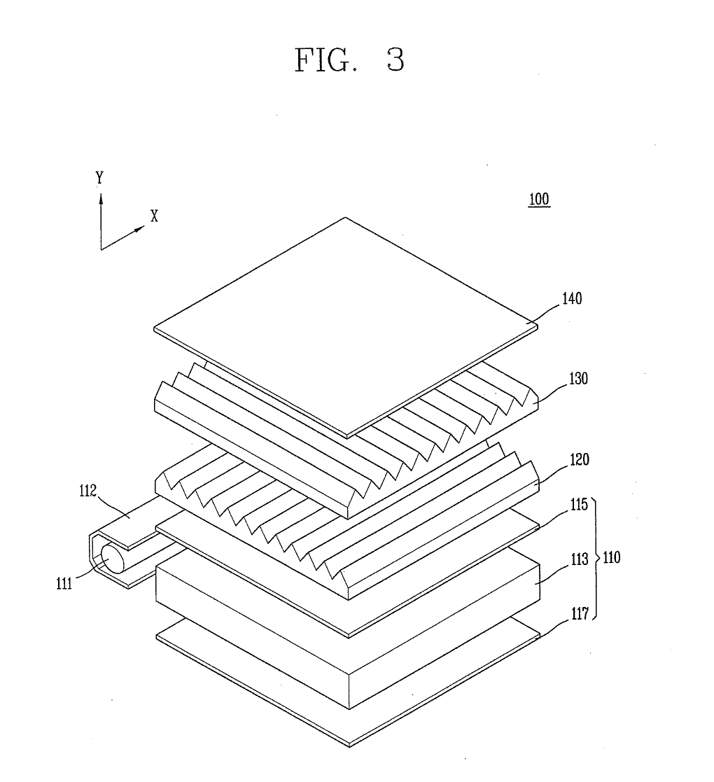

### DETAILED DESCRIPTION OF THE INVENTION

Description will now be given in detail of the present invention, with reference to the accompanying drawings.

Hereinafter, a backlight unit, and an LCD device having the same according to the present invention will be explained in more detail.

FIG. 3 is a disassembled perspective view showing a structure of an LCD device according to the present invention.

As shown in FIG. 3, an LCD device 100 comprises an LC panel 140, and a backlight unit 110. The backlight unit 110 is disposed below the LC panel 140, and supplies light to the LC panel 140.

The backlight unit 110 comprises an optical source composed of lamps; a housing 112 for accommodating the optical source 111 therein; a light guide panel 113 disposed below the LC panel 140 so that side surfaces thereof can contact the optical surface 111, for supplying light incident thereon through the side surfaces to the LC panel 140; a reflector 117 disposed below the light guide panel 113, for reflecting light incident to a lower side of the light guide panel 113 to the LC panel 140; a diffusion sheet 115 disposed between the LC panel 140 and the light guide panel 113, for diffusing light guided by the light guide panel 113; a first prism sheet 120 disposed between the diffusion sheet 115 and the LC panel 140, and having a plurality of prisms thereon disposed in one direction, for forwardly refracting light diffused by the diffusion sheet 115; and a second prism sheet 130 disposed above the first prism sheet 120, and having a plurality of prisms thereon disposed in another direction, for refracting again the light refracted by the first prism sheet 120.

Although not shown, a passivation film for protecting the optical sheet disposed therebelow may be further provided above the second prism sheet 130.

The prisms on the first prism sheet 120 are disposed to be perpendicular to the prisms on the second prism sheet 130. And, the prisms on the first and second prism sheets 120 and 130 refract incident light to a front side, thereby enhancing a frontal brightness of the light. As shown in FIG. 3, the prisms on the first and second prism sheets 120 and 130 are arranged in different directions, i.e., x and y directions perpendicular to each other. Accordingly, incident light is made to be refracted in the x and y directions, thereby being made to be vertically incident to the LC panel 140.

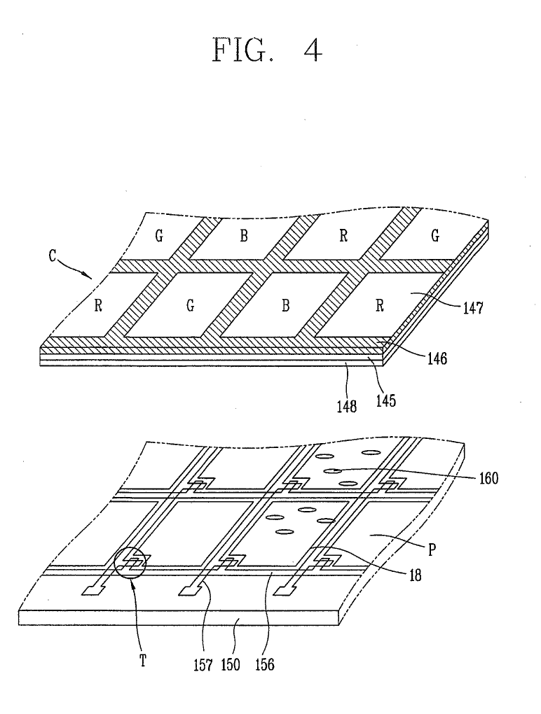

As shown in FIG. 4, the LC panel 140 includes a first substrate 150, a second substrate 145, and an LC layer (not shown) disposed therebetween. On the first substrate 150, a plurality of gate lines 156 and data lines 157 are arranged in the form of matrixes, thereby defining a plurality of pixel regions (P). On each pixel region (P), formed are a thin film transistor (T), and a pixel electrode 158 electrically connected to the thin film transistor (T). Gate pads and data pads are formed at the ends of the gate lines 156 and the data lines 157, thereby connecting the gate lines 156 and the data lines 157 to an external driving device. Accordingly, an external signal is input to the LC panel 140 through the gate lines 156 and the data lines 157.

Although not shown, the thin film transistor (T) includes a gate electrode connected to the gate line 156, and receiving a scan signal from outside through the gate line 156; a gate insulation layer disposed above the gate electrode; a semiconductor layer disposed above the gate insulation layer, and forming a channel region by being activated as the scan signal is input to the gate electrode; and source and drain electrodes formed on the semiconductor layer, for applying image signals to the pixel electrode 158, the image signals input through the data line 157 as the channel region is formed on the semiconductor layer by the scan signal.

On the second substrate 145, formed are a black matrix and a color filter layer 147 formed of sub color filter layers of red, green and blue (R, G and B). The black matrix is formed at an image non-display region, such as the gate lines 156, the data lines 157 and the thin film transistors (T) where images are not substantially displayed, and prevents inferiority of screen quality occurring as light is incident onto the image non-display region. And, the color filter layer 147 is formed at a pixel region, and substantially implements images.

As the LC layer (not shown) is formed between the first substrate 150 and the second substrate 145, the LC panel 140 is implemented.

As the optical source 111, fluorescent lamps such as Cold Cathode Fluorescent Lamps (CCFL) may be used. A reflection layer is formed on an inner surface of the housing 112 in which the optical source 111 is accommodated, thereby reflecting light emitted from the optical source 111 to the light guide panel 113. As shown in FIG. 3, the optical source 111 may be formed only at one side of the light guide panel 113. Alternatively, the optical source 111 may be formed at both sides of the light guide panel 113, thereby allowing light emitted from the optical source 111 to be made incident onto the light guide panel 113 through the both side surfaces of the light guide panel 113.

As the optical source 111, a Light Emitting Device (LED) may be also used. The LED is an optical source which spontaneously emits monochromatic light such as R, G and B. Accordingly, when being applied to the backlight unit, the LED implements an excellent color reproduction rate, and reduces driving power.

In the case of using the LED as the optical source 111 of the backlight unit, light emitted from the LED is supplied to the LC panel as white light not as monochromatic light. In order to make monochromatic light emitted from the light emitting device into white light, a monochromatic light emitting device and a fluorescent body are used. Alternatively, an infrared-ray light emitting device and a fluorescent body are used. Still alternatively, each monochromatic light emitted from R, G and B light emitting devices is mixed to each other. That is, in the case of using the LED as the optical source 111 of the backlight unit, a plurality of LEDs are arranged on side surfaces of the light guide panel 113, thereby allowing white light or monochromatic light to be incident on the light guide panel 113.

The light guide panel 113 is formed of Polymethyl-Methacrylate (PMMA). Once light is made to be incident onto an upper or lower surface inside the light guide panel 113 through one side surface or both side surfaces of the light guide panel 113 with an angle less than a threshold angle, the light is totally reflected to progress from one side to another side of the light guide panel 113. On the contrary, when light is made to be incident onto an upper or lower surface inside the light guide panel 113 with an angle more than a threshold angle, the light is outwardly outputted to be reflected by the reflector 117, or to be made to be incident onto the diffusion sheet 115.

The diffusion sheet 115 serves to diffuse light emitted from the light guide panel 113, thereby having a uniform brightness. And, the diffusion sheet 115 is fabricated by distributing spherical-shaped seeds formed of acryl resin on a base film formed of polyester (PET). That is, light emitted from the light guide panel 113 is diffused by the spherical-shaped seeds thus to have a uniform brightness. The diffusion sheet 115 is arranged between the light guide panel 113 and the first prism sheet 120. However, the diffusion sheet 115 may be also provided between the second prism sheet 130 and the LC panel 140.

The prism sheets 120 and 130 are fabricated by regularly forming prisms formed of acryl-based resin on a base film formed of polyester (PET). And, the prism sheets 120 and 130 make light to be incident thereon in a front direction, i.e., in a direction perpendicular to the surface of the LC panel 140 by refracting the incident light. The prism sheet 120 will be explained in more detail.

As shown in FIG. 3, the prism sheet is composed of the first prism sheet 120 and the second prism sheet 130. And, the first and second prism sheets 120 and 130 concentrate light by refracting light diffused by the diffusion sheet 115 in horizontal and vertical directions, thereby enhancing brightness.

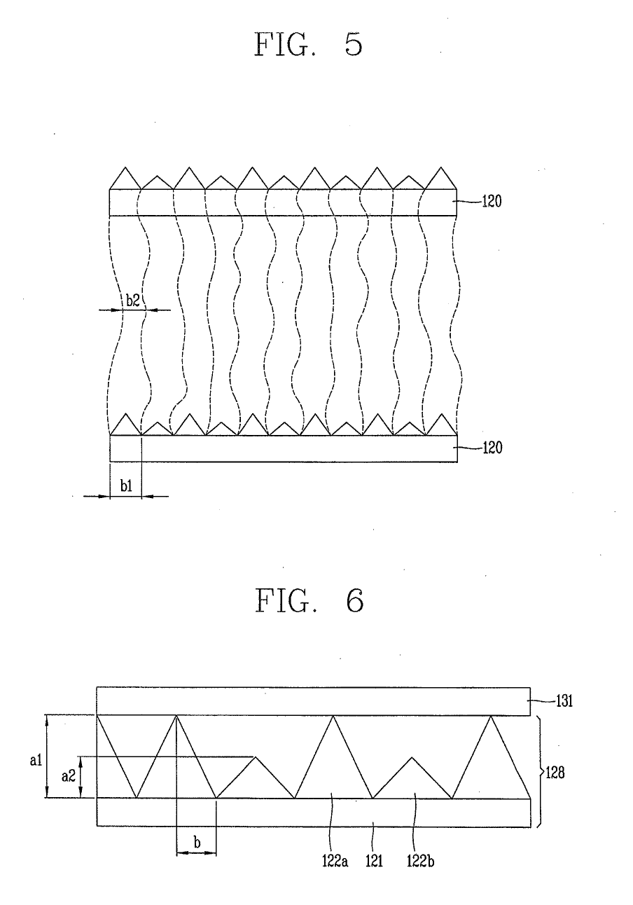

FIG. 5 shows a structure of the first prism sheet 120. the second prism sheet 130 has a similar structure as the first prism sheet 120. Accordingly, detailed explanations for the second prism sheet 130 will be omitted, and only a different structure from the first prism sheet 120 will be explained.

As shown in FIG. 5, the first prism sheet 120 includes a first base film 121, and prisms 122 formed on the first base film 121 and having triangle shaped cross sections such as mountains. The first base film 121 is formed of acryl-based resin, and the prisms 122 are extending from one side to another side on the entire surface of the first base film 122. As the prisms 122, a plurality of isosceles triangles are implemented.

On the entire parts of the first prism sheet 120, the height of the prisms 122, and the bottom widths having triangle shaped cross sections may be constant. However, the height and the widths of the prisms differently formed due to the following reasons.

Firstly, when the prisms 122 are formed on the entire parts of the first prism sheet 120 with a constant bottom width having a triangular shape, i.e., when the prisms 122 are formed on the entire parts of the first prism sheet 120 with regular patterns, the same type of interference occurs due to the regular optical patterns refracted by the prisms 122. This may cause a moiré pattern on a screen.

Secondly, when the prisms are formed on the entire parts of the first prism sheet 120 with a uniform height, humidity is introduced from the outside thus to cause a wet-out phenomenon.

In the present invention, the prisms 122 on the first prism sheet 120 are formed to have different sectional surfaces having irregular triangular widths, thereby preventing the occurrence of a moiré pattern due to regular interference. Furthermore, in the present invention, the prisms 122 are formed to have different heights from each other, thereby minimizing the wet-out phenomenon.

In order to form the irregular prisms 122, the bottom width having the triangle shaped cross section is differently set according to a central portion and edge portions.

All the prisms 122 may be irregularly formed on the entire parts of the first prism sheet 120. However, since the first prism sheet 120 serves to vertically apply light to the LC panel 140 by refracting the light in horizontal and vertical directions, there is a limitation in an irregular degree of the prisms 122. That is, in order to perform a function of the first prism sheet 12 and to obtain irregularity of the prisms 122, the irregularly of the prisms 12 is maximized by controlling the bottom widths of the prisms 122.

More concretely, in the present invention, the prism 122 is irregularly formed by differently forming the bottom widths having triangle shaped cross sections according to positions of one prism extending in an isosceles triangle

Especially, in the present invention, the bottom widths of one prism are differently set according to a central portion and edge portions of the first prism sheet 120.

One prism 122 may have different bottom widths having triangle shaped cross sections according to positions. And, a bottom width having a triangle shaped cross section of one prism 122 may be different from a bottom width having a triangle shaped cross section of another prism 122.

In the present invention, one prism implemented as an isosceles triangle is formed to have the same height. However, said one prism is implemented to have a different height from the other prism adjacent thereto.

It is possible to form all the prisms 122 on the first prism sheet 120 with different heights. And, it is also possible to form only some parts of the prisms 122 on the first prism sheet 120 with different heights. However, in the case of forming all the prisms 122 on the first prism sheet 120 with different heights, the fabrication processes for the first prism sheet 120 become complicated, and the fabrication costs are increased. Accordingly, in the present invention, only the prisms 122 adjacent to each other are configured to have different heights, and the two adjacent prisms 122 having different heights are formed on the entire parts of the first prism sheet 120. Under this configuration, even if humidity is introduced into the LCD device, cling of the prisms 122 on the first prism sheet 120 to the second prism sheet 130 disposed thereabove is minimized, thereby minimizing the wet-out phenomenon.

FIG. 6 is a partially enlarged sectional view of the first prism sheet 120 of the LCD device according to the present invention.

As shown in FIG. 6, the base film 121 of the first prism sheet 120 is provided with a plurality of prisms 122. The prisms 122 include first prisms 122a having a height of ‘a1’, and second prisms 122a having a height of ‘a2’. Here, the height (a1) of the first prisms 122a is about 27 μm, and the height (a2) of the second prisms 122b is about 25.5-25.8 μm. That is, the difference (a1−a2) between the height (a1) of the first prisms 122a and the height (a2) of the second prisms 122b is approximately 1.2-1.5 μm.

The reason why the height (a2) of the second prisms 122b is lower than the height (a1) of the first prisms 122a is in order to minimize the wet-out phenomenon that the prisms on the first prism sheet 120 cling to the second prism sheet 130 due to humidity introduced into the LCD device. More concretely, since the height (a2) of the second prisms 122b is lower than the height (a1) of the first prisms 122a, only the first prisms 122a cling to the second prism sheet 130 due to humidity introduced into the LCD device, thereby minimizing the wet-out phenomenon. In the present invention, when the prisms 122a and 122b adjacent to each other are configured to have different heights from each other, inferiority of the LCD device due to the wet-out phenomenon by introduced humidity is prevented.

Hereinafter, will be explained the reasons why the difference (a1−a2) between the height (a1) of the first prisms 122a and the height (a2) of the second prisms 122b is approximately 1.2-1.5 μm.

When the LCD device is applied to a notebook, etc., a lower cover of the LCD device is integrally formed with a reflector, thus to have a very weak intensity. Accordingly, when the LCD device is pressed by a connector disposed below the notebook, etc., an impact is applied to the prism sheet. Furthermore, the LC Panel having the optical sheet attached thereto and completed when fabricating the LCD device is experimented in a held state on a plate disposed at a predetermined angle. This may cause the first prism sheet 120 to be pressed by a component such as the connector connected to the LC panel.

In the case of configuring the first prisms 122a on the first prism sheet 120 to have a different height from the second prisms 122b, when the first prism sheet 120 is pressed, the first prisms 122a come in contact with the second prism sheet 130 to receive the pressure. On the contrary, the second prisms 122b do not come in contact with the second prism sheet 130. That is, the pressure is concentrated on all the first prisms 122a. Due to the concentrated pressure, the first prisms 122a may have deformed shapes or lowered heights. This may cause incident light to be distorted at the parts where the shape deformation of the first prisms 122a occurs or the heights of the first prisms 122a are lowered. This optical distortion may result in a white point phenomenon that white points occur on a screen.

Once the pressure is continuously applied to the first prism sheet 120 for a long time, the lowered heights or deformed shapes of the first prisms 122a are not restored to the originals states. This may result in great defects of the LCD device.

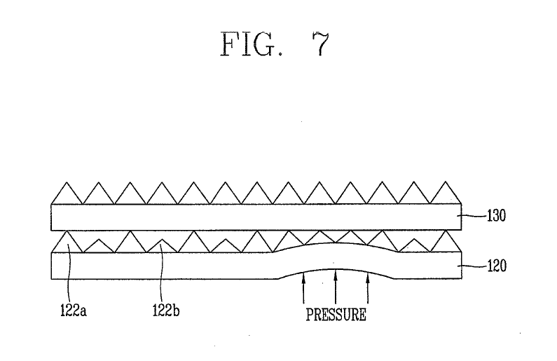

In the present invention, the difference (a1−a2) between the height (a1) of the first prisms 122a and the height (a2) of the second prisms 122b is configured as about 1.2-1.5 μm, thereby preventing the shape deformation of the first prisms 122a due to a pressure applied thereto. That is, under this configuration, when a pressure is applied to the first prism sheet 120 as shown in FIG. 7, not only the first prisms 122a but also the second prisms 122b come in contact with the second prism sheet 130. This may allow the pressure to be distributed to the first prisms 122a and the second prisms 122b. As a result, the shape deformation of the first prisms 122a due to a concentrated pressure on the first prisms 122a may be prevented.

Since the height of the second prisms 122b is different from the height of the first prisms 122a, the wet-out phenomenon is minimized even when humidity is introduced into the LCD device.

That is, in the case of configuring the difference (a1−a2) between the height (a1) of the first prisms 122a and the height (a2) of the second prisms 122b to be more than 1.5 μm, only the first prisms 122a come in contact with the second prism sheet 130 when a pressure is applied to the first prism sheet 120. This may cause shape deformation of the first prisms 122a, thereby distorting light passing through the first prisms 122a.

On the other hand, in the case of configuring the difference (a1−a2) between the height (a1) of the first prisms 122a and the height (a2) of the second prisms 122b to be less than 1.2 μm, not only the first prisms 122a but also the second prisms 122b may cling to the second prism sheet 130 when moisture is introduced into the LCD device. This may result in the wet-out phenomenon.

In summary, in the present invention, the wet-out phenomenon is prevented by setting the difference (a1−a2) between the height (a1) of the first prisms 122a and the height (a2) of the second prisms 122b is configured as 1.2-1.5 μm. And, a pressure applied to the first prism sheet 120 is distributed to prevent the specific prisms from having deformed shapes.

Furthermore, a bottom width of a triangle shaped cross section of one first prism 122a on the first prism sheet 120 may be configured as about 125 μm or 188p. The width may become different according to positions, thereby increasing irregularity of the first prisms 122a. The width of the triangle shaped cross section may be the largest at a central portion of the first prism sheet 120, whereas it may be narrowest at edge portions of the first prism sheet 120. However, it is also possible that the width of the triangle shaped cross section may be the largest at the edge portions of the first prism sheet 120, whereas it may be narrowest at the central portion of the first prism sheet 120. Preferably, a width difference between the triangle shaped cross section of the first prism 122a at the central portion of the first prism sheet 120, and that at the edge portion of the first prism sheet 120 is in a range of 1.2-1.5 μm.

The width of the triangle shaped cross section of the first prism 122a need not be maximized or minimized at a specific position. The reason why one first prism 122a has different widths of triangle shaped cross sections is in order to prevent the occurrence of a moiré pattern by increasing irregularity of the first prisms 122a. Accordingly, as long as the irregularity of the first prism 122a can be increased, the width of the triangle shaped cross section of the first prism 122a may be maximized or minimized at any position. Accordingly, it is not configured that a width difference between the triangle shaped cross section of the first prism 122a at the central portion of the first prism sheet 120, and that at the edge portion of the first prism sheet 120 is in a range of 1.2-1.5 μm. But, it is configured that a width difference between the triangle shaped cross sections of one first prism 122a is in a range of 1.2-1.5 μm.

The prisms formed on the second prism sheet 130 may have triangular or isosceles triangle shaped cross sections, and may be long extending from one side of the second prism sheet 130 to another side. Preferably, the prisms of the second prism sheet 130 are formed as irregular patterns so as to prevent the occurrence of a moiré pattern on a screen. That is, widths of the triangle shaped cross sections of one prism may become different according to positions. Preferably, a bottom width difference between the triangle shaped cross sections of the prism on the second prism sheet 130 is in a range of 1.2-1.5 μm.

As aforementioned, the prisms adjacent to each other on the first prism sheet are irregularly formed to have different heights from each other, and the height difference therebetween is configured to be in a range of 1.2-1.5 μm, thereby preventing the wet-out phenomenon.

Furthermore, even when the prisms on the first prism sheet come in contact with the second prisms as a pressure is applied to the first prism sheet, may be prevented shape deformation of the specific prisms due to pressure concentration on the specific prisms on the first prism sheet.

In the aforementioned descriptions, the LC panel and the backlight unit are implemented as specific structures for convenience. However, the present invention may not limited to this. For instance, the extending direction of the prisms on the first prism sheet may be opposite to that of the prisms on the second prism sheet. And, the diffusion sheet may be implemented in one, not in two.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A prism sheet, comprising:
a base film; and
a plurality of prisms formed on the base film, the prism being extended from one side to another side of the base film and having triangle shaped cross section,
wherein the prisms adjacent to each other have different heights, and a height difference between the adjacent prisms is approximately 1.2-1.5 μm.

2. The prism sheet of claim 1, wherein the prisms adjacent to each other have heights of 27 μm and 25.5-25.8 μm, respectively.

3. The prism sheet of claim 1, wherein bottom widths of the triangle shaped cross section of one prism are different according to positions.

4. The prism sheet of claim 3, wherein a bottom width difference between the triangle shaped cross section of the prism at a central portion of the base film and that at an edge portion of the base film is in a range of 1.2-1.5 μm.

5. A backlight unit, comprising:
at least one lamp for emitting light;
a light guide panel for guiding the light emitted from the lamp;
at least one diffusion sheet above the light guide panel to diffuse the light incident from the light guide panel;
a first prism sheet having a plurality of prisms formed thereon to concentrate the incident light, the prisms having triangle shaped cross section and height differences between the adjacent prisms is approximately 1.2-1.5 μm; and
a second prism sheet above the first prism sheet, the second prism having a plurality of prisms of triangle shaped cross section.

6. The backlight unit of claim 5, wherein all the prisms on the first prism sheet come in contact with the second prism sheet when a pressure is applied to the first prism sheet, thereby the pressure applied to the first prism sheet is distributed to all the prisms on the first prism sheet.

7. The backlight unit of claim 5, wherein a bottom width difference between the triangle shaped cross section of the prism at a central portion of the first prism sheet and that at an edge portion of the first prism sheet is approximately 1.2-1.5 μm.

8. The backlight unit of claim 5, wherein a bottom width difference between the triangle shaped cross section of the prism at a central portion of the second prism sheet, and that at an edge portion of the second prism sheet is approximately 1.2-1.5 μm.

9. The backlight unit of claim 5, wherein the adjacent prisms on the second prism sheet have different heights from each other.

10. A liquid crystal display (LCD) device, comprising:
an LCD panel for displaying an image;
at least one lamp for emitting light;
a light guide panel for guiding the light emitted from the lamp to the LCD panel;
at least one diffusion sheet above the light guide panel to diffuse the light incident from the light guide panel;
a first prism sheet having a plurality of prisms formed thereon to concentrate the incident light and supplying the concentrated light to the LCD panel, the prisms having triangle shaped cross section and height differences between the adjacent prisms is approximately 1.2-1.5 μm; and
a second prism sheet above the first prism sheet, the second prism having a plurality of prisms of triangle shaped cross section.
